(19) United States
(12) Patent Application Publication
(10) Pub. No.: US 2021/0005194 A1
(43) Pub. Date: Jan. 7, 2021

(54) ELECTRIC DEVICE, CONTROL METHOD OF ELECTRIC DEVICE, AND STORAGE MEDIUM

(71) Applicant: SHARP KABUSHIKI KAISHA, Osaka (JP)

(72) Inventor: YUICHI NISHII, Osaka (JP)

(21) Appl. No.: 16/915,251

(22) Filed: Jun. 29, 2020

(30) Foreign Application Priority Data
Jul. 2, 2019 (JP) 2019-123887

(51) Int. Cl. G10L 15/22; G10L 15/30

(52) U.S. Cl. CPC G10L 15/22; G10L 2015/223; G10L 15/30

(57) ABSTRACT

Provided is an electric device including a function executer that executes a predetermined function, a communicator that communicates with a voice recognition server and receives an execution command corresponding to a voice command from the voice recognition server, an execution state detector that detects an execution state of the predetermined function, a message outputter that outputs a message relating to the execution state of the function, and a controller that controls the function executer, the communicator, the execution state detector, and the message outputter. If the communicator receives an execution command from the voice recognition server, the controller causes the execution state detector to detect the execution state of the predetermined function, and if the predetermined function is executable, the controller causes the function executer to execute the predetermined function, whereas if the predetermined function is not executable, the controller causes the message outputter to output a related message.

### BACKGROUND OF THE INVENTION

### Field of the Invention

The present invention relates to an electric device, a control method of the electric device, and a storage medium. More specifically, the present invention relates to an electric device for communicating with a voice recognition server that recognizes a voice command of a user input from an external speaker, and receiving and executing an execution command of a predetermined function corresponding to the voice command from the voice recognition server, and relates also to a control method of the electric device and a storage medium.

### Description of the Background Art

In recent years, there is an increasing use of electric devices such as Alexa (registered trademark) and Google Home (registered trademark) that can link with a smart speaker having an AI assistant function supporting interactive voice operations, and can receive operations by a user's voice.

As an invention of an electric device capable of performing such a voice input operation, there is disclosed an invention of an image processing system that imparts a new function to an image processing device by an application from an external information processing device. In this image processing system, a user performs a voice input operation on an operation screen displayed on a display of the image processing device based on the application (see, for example, Japanese Unexamined Patent Application Publication No. 2011-049705).

Further, there is also disclosed an invention of an image forming apparatus that performs a voice operation. This image forming apparatus determines whether it is possible to start an operation of the apparatus in response to a voice recognized by voice input, and outputs an operation guide voice in accordance with the determination result (see, for example, Japanese Unexamined Patent Application Publication No. 2007-058432).

However, in a system in which a user performs a voice input operation on an electric device via a voice recognition server of an AI assistant provided by another company, the voice recognition server typically only executes an execution command of a predetermined function to the electric device based on a result of the user's voice recognition, and thus, an appropriate operation in accordance with a function of the electric device is often not performed.

The present invention has been made in consideration of the above circumstances, and an object thereof is to provide an electric device, a control method of the electric device, and a storage medium, by which it is possible to return an appropriate response in accordance with an execution state of the electric device if an execution command of a predetermined function is received from a voice recognition server that recognizes audio data input from a smart speaker.

### SUMMARY OF THE INVENTION

(1) The present invention provides an electric device including a function executer that executes a predetermined function, a communicator that communicates with a voice recognition server recognizing a voice command input by a user through an external voice input/output device and receives a command to execute the predetermined function, which corresponds to the voice command, from the voice recognition server, an execution state detector that detects an execution state of the predetermined function, a message outputter that outputs a message related to the execution state of the predetermined function, and a controller that controls the function executer, the communicator, the execution state detector, and the message outputter, in which, when the communicator receives the command to execute the predetermined function from the voice recognition server, the controller causes the execution state detector to detect the execution state of the predetermined function, the controller causes the function executer to execute the predetermined function if the execution state detector detects that the predetermined function is executable, and the controller causes the message outputter to output the message related to the execution state of the predetermined function if the execution state detector detects that the predetermined function is not executable.

Further, the present invention provides a method of controlling an electric device that communicates with a voice recognition server recognizing a voice command input by a user through an external voice input/output device and executes a predetermined function corresponding to the voice command according to a command from the voice recognition server, the method including communicating with the voice recognition server and receiving a command to execute a function corresponding to the voice command from the voice recognition server, detecting an execution state of the function, executing the function, and outputting a message related to the execution state of the function. When the command to execute the function is received from the voice recognition server in the receiving, the execution state of the function is detected in the detecting and, if it is detected that the function is executable, the function is executed in the executing, and if it is detected in the detecting that the function is not executable, the message related to the execution state of the function is output in the outputting.

Further, the present invention provides a non-transitory recording medium storing a control program for an electric device that communicates with a voice recognition server recognizing a voice command input by a user through an external voice input/output device and executes a predetermined function corresponding to the voice command according to a command from the voice recognition server. The control program causes a processor of the electric device to execute a communication process for communicating with the voice recognition server and receiving a command to execute a function corresponding to the voice command from the voice recognition server, an execution state detection process for detecting an execution state of the function, a function execution process for executing the function, and a message output process for outputting a message related to the execution state of the function. When the command to execute the function is received from the voice recognition server in the communication process, the execution state of the function is detected in the execution state detection process, and, if it is detected that the function is executable, the function is executed in the function execution process, and, if it is detected in the execution state detection process that the function is not executable, a message related to the execution state of the function is output in the message output process.

In the present invention, the “predetermined function” is, for example, a copying, scanning, FAX transmission, or email transmission function of an image forming apparatus such as a multifunctional apparatus, an image display function of an image display device such as a television and a DVD recorder, a cleaning function of an electric vacuum cleaner such as a self-propelled vacuum cleaner, a cooking function of an electric cooker or the like, a hot water filling function of a bathtub, an air-conditioning function of an air conditioner, an air cleaning function of an air cleaner or the like, a sound reproduction function of an audio device, and the like.

One electric device may have a plurality of different functions.

In the present invention, the “voice input/output device” is, for example, a speaker such as a smart speaker that receives a voice input from a user, converts the voice input into predetermined audio data, and transmits the audio data to a voice recognition server.

The “voice recognition server” acquires the audio data input from the voice input/output device, performs voice recognition, and transmits an execution command of a function in accordance with the recognized voice to the electric device.

According to the present invention, if an execution command of a predetermined function is received from a voice recognition server that recognizes audio data input from a smart speaker, it is possible to realize an electric device capable of returning an appropriate response in accordance with the execution state of the electric device.

Further, preferable aspects of the present invention will be described.
(2) After the communicator receives an execution command of the function from the voice recognition server, in a case where the function is executable and the function executer is caused to execute the function, if the execution state detector subsequently detects that the function is no longer executable, the controller may cause the message outputter to output a message relating to the execution state of the function.

In this way, after execution of a predetermined function based on an execution command received from a voice recognition server, if the function is no longer executable, a message relating to the execution state of the function is output, and thus, it is possible to realize an electric device capable of returning an appropriate response in accordance with the execution state of the electric device.
(3) After the communicator receives an execution command of the function from the voice recognition server, in a case where the function is not executable and the message outputter is caused to output a message relating to an execution state of the function, if the execution state detector subsequently detects that the function is executable, the controller may cause the function executer to execute the function.

In this way, after a message indicating that a function is not executable according to an execution command received from a voice recognition server is output, if the problem that the function is not executable is resolved, the function is executed, and thus, it is possible to realize an electric device capable of returning an appropriate response in accordance with the execution state of the electric device.
(4) The electric device further includes an error detector that detects an abnormality in an execution state of the function, and after the communicator receives an execution command of the function from the voice recognition server, in a case where the function is executable and the function executer is caused to execute the function, if the error detector detects an abnormality in the execution state of the function, the controller may cause the message outputter to output a message relating to the abnormality in the execution state, and may cause the function executer to stop the execution of the function.

An “abnormality in an execution state of the function” refers to a case where, even though the function is executable according to the execution command received from the voice recognition server, a problem occurs in the execution of the function, such as an extreme delay in the execution state and a quality problem.

Examples include a case where the amount of hot water in a bathtub hardly increases if a tub stopper is pulled out while filling hot water in a bathtub, or a case where a printing color on a sheet is light if the remaining amount of toner is low.

In this way, after a predetermined function is executed based on an execution command received from a voice recognition server, if an abnormality is detected in an execution state of the function, a message relating to the abnormality in the execution state of the function is output and the execution of the function is stopped, and thus, it is possible to realize an electric device capable of returning an appropriate response in accordance with the execution state of the electric device.
(5) If the communicator receives an execution command of the function from the voice recognition server, the controller causes the execution state detector to detect an execution state of the function, and if the execution state detector detects that the function is executable but the execution state of the function is in a state requiring attention, the controller may cause the message outputter to output a message relating to the state requiring attention.

The “state requiring attention” is a state in which although a function is executable according to an execution command received from a voice recognition server, it is necessary to replace a component of the electric device, or perform maintenance.

For example, the “state requiring attention” includes a state where it is necessary to clean a filter of an air conditioner if the filter is dirty. In this case, a difference from an aspect described above in (4) is that although the efficiency of the air conditioner deteriorates, the execution of an air-conditioning function is not hindered, and it is not necessary to stop the execution of the function.

In this way, if it is possible to execute a predetermined function based on an execution command received from a voice recognition server, but the execution state of the function is in a state requiring attention, a message indicating the same is output, and thus, it is possible to realize an electric device capable of returning an appropriate response in accordance with the execution state of the electric device.
(6) The function executer may execute an image forming function of forming an image.

In this way, if an execution command of an image forming function is received from a voice recognition server that recognizes audio data input from a smart speaker, it is possible to realize an electric device capable of returning an appropriate response in accordance with an execution state of the electric device.

### BRIEF DESCRIPTION OF DRAWINGS

FIG. 1 is an explanatory diagram illustrating an appearance of a multifunctional apparatus system according to the present invention;

FIG. 2 is a block diagram illustrating a simplified configuration of a digital multifunctional apparatus illustrated in FIG. 1;

FIG. 3 is a block diagram illustrating a simplified configuration of a smart speaker illustrated in FIG. 1;

FIG. 4 is a block diagram illustrating a simplified configuration of a voice recognition server illustrated in FIG. 1;

FIGS. 5A to 5C are explanatory diagrams illustrating an example of a voice operation procedure of a conventional multifunctional apparatus system;

FIG. 6 is a flowchart illustrating a process of the smart speaker in the voice operation procedure of the multifunctional apparatus system illustrated in FIG. 1;

FIG. 7 is a flowchart illustrating a process of the voice recognition server in the voice operation procedure of the multifunctional apparatus system of FIG. 1;

FIG. 8 is a flowchart illustrating a process of the digital multifunctional apparatus in the voice operation procedure of the multifunctional apparatus system of FIG. 1;

FIGS. 9A to 9C are explanatory diagrams illustrating an example of the voice operation procedure of the multifunctional apparatus system of FIG. 1;

FIGS. 10A to 10C are explanatory diagrams illustrating an example of a voice operation procedure of a television system according to a first embodiment of the present invention;

FIG. 11 is a flowchart illustrating a process of an electric device in a voice operation procedure of a multifunctional apparatus system according to a second embodiment of the present invention;

FIGS. 12A to 12C are explanatory diagrams illustrating an example of the voice operation procedure of the multifunctional apparatus system according to the second embodiment of the present invention;

FIGS. 13A to 13C are explanatory diagrams illustrating an example of a voice operation procedure of a self-propelled vacuum cleaner system according to the second embodiment of the present invention;

FIG. 14 is a flowchart illustrating a process of an electric cooker in a voice operation procedure of an electric cooker system according to a third embodiment of the present invention;

FIGS. 15A to 15C are explanatory diagrams illustrating an example of the voice operation procedure of the electric cooker system according to the third embodiment of the present invention;

FIG. 16 is a flowchart illustrating a process of a remote controller in a voice operation procedure of an automatic water heater system according to a fourth embodiment of the present invention;

FIGS. 17A to 17C are explanatory diagrams illustrating an example of the voice operation procedure of the automatic water heater system according to the fourth embodiment of the present invention;

FIG. 18 is a flowchart illustrating a process of an air conditioner in a voice operation procedure of an air conditioner system according to a fifth embodiment of the present invention; and

FIGS. 19A and 19B are explanatory diagrams illustrating an example of the voice operation procedure of the air conditioner system according to the fifth embodiment of the present invention.

### DESCRIPTION OF THE PREFERRED EMBODIMENTS

The present invention will be described below in more detail with reference to the drawings. It is noted that the following description is an exemplified illustration in all aspects and should not be interpreted to limit the present invention.

### First Embodiment

### Simplified Configuration of Multifunctional Apparatus System 100

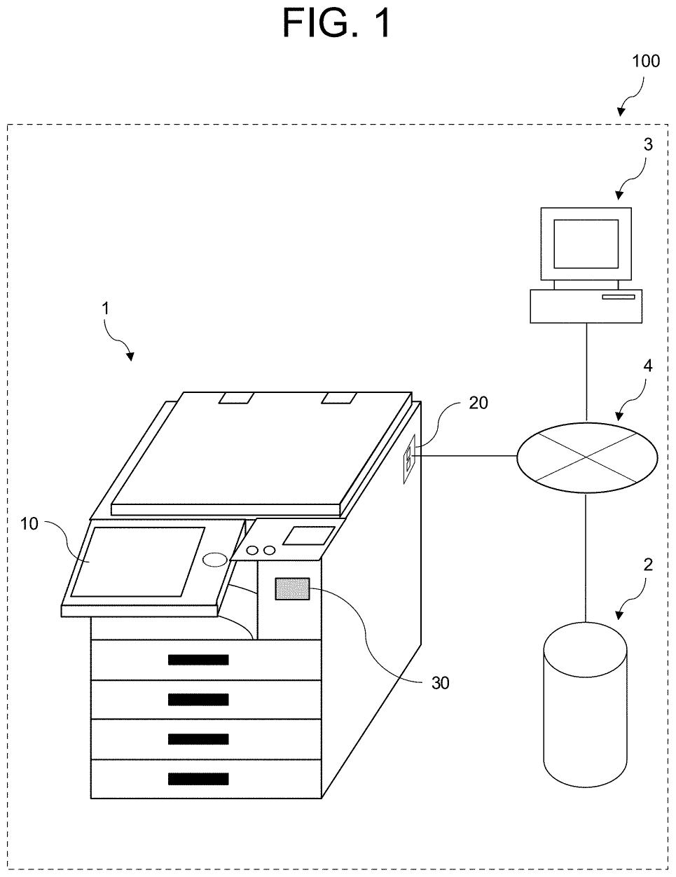

A multifunctional apparatus system 100 being an embodiment of an electric device according to the present invention will be described with reference to FIGS. 1 to 4.

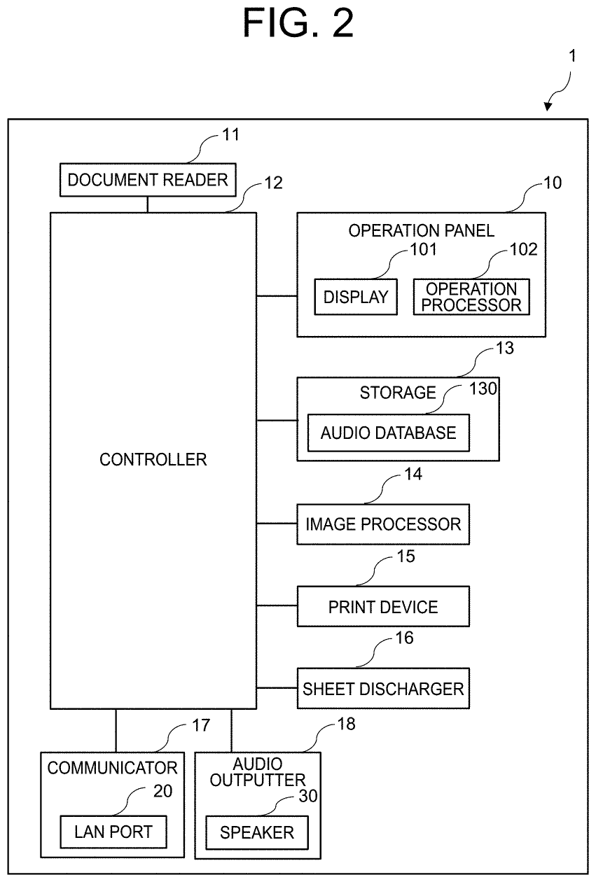

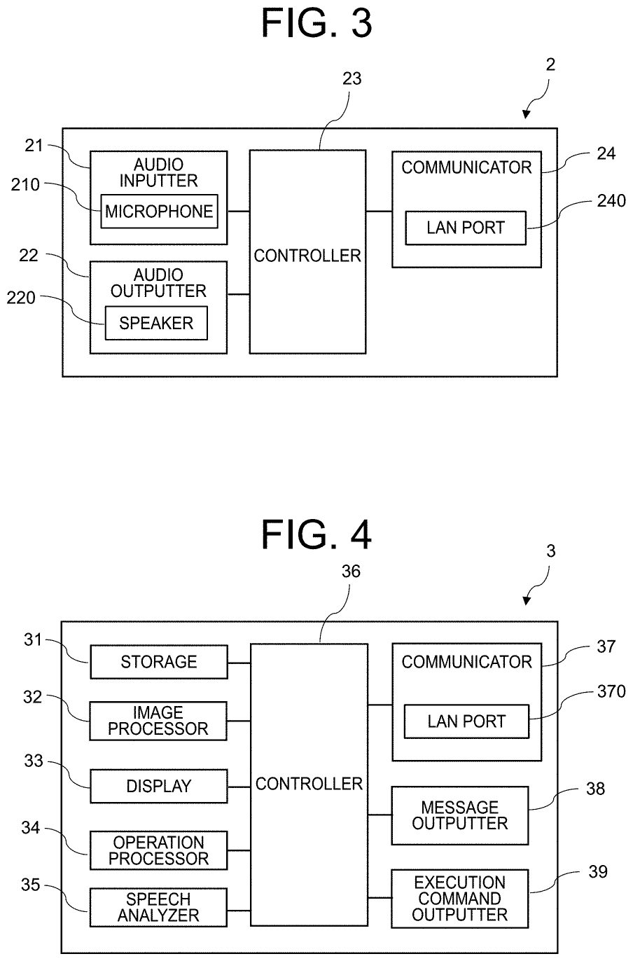

FIG. 1 is an explanatory diagram illustrating an appearance of the multifunctional apparatus system 100 according to the present invention. FIG. 2 is a block diagram illustrating a simplified configuration of a digital multifunctional apparatus 1 illustrated in FIG. 1. FIG. 3 is a block diagram illustrating a simplified configuration of a smart speaker 2 illustrated in FIG. 1. FIG. 4 is a block diagram illustrating a simplified configuration of a voice recognition server 3 illustrated in FIG. 1.

The multifunctional apparatus system 100 is configured by the digital multifunctional apparatus 1, the smart speaker 2, the voice recognition server 3, and a network 4.

The digital multifunctional apparatus 1 is, for example, a multifunction peripheral (MFP) having a copying function, a scanning function, and a facsimile function that performs digital processing of image data.

As illustrated in FIG. 1, the digital multifunctional apparatus 1 includes an operation panel 10 that displays various types of information and performs various types of operations, a LAN port 20 for connecting to the voice recognition server 3 via the network 4, and a speaker 30 that performs audio output.

Buttons and information for operating the digital multifunctional apparatus 1 are displayed on the operation panel 10, and the user operates a touch panel based on the displayed information to use a function of the digital multifunctional apparatus 1.

The smart speaker 2 includes a built-in microphone and receives a voice input from a user, converts the voice input into predetermined audio data, and transmits the audio data to the voice recognition server 3.

Further, the smart speaker 2 receives the audio data from the voice recognition server 3, converts the audio data into a sound, and outputs the sound.

The voice recognition server 3 acquires the audio data input from the smart speaker 2 via the network 4, performs voice recognition, and transmits an execution command of a function in accordance with the recognized voice to the digital multifunctional apparatus 1.

As illustrated in FIG. 2, the digital multifunctional apparatus 1 includes the operation panel 10, a document reader 11, a controller 12, a storage 13, an image processor 14, a print device 15, a sheet discharger 16, a communicator 17, and an audio outputter 18.

In the first embodiment, a “voice input/output device” according to the present invention is realized by the smart speaker 2. A “function executer” according to the present invention is realized by a cooperation of the document reader 11, the controller 12, the image processor 14, the print device 15, and the sheet discharger 16. An “execution state detector” according to the present invention is realized by the controller 12. Further, a “message outputter” according to the present invention is realized by the audio outputter 18.

The constituent components of the digital multifunctional apparatus 1 will be described below.

The operation panel 10 has a liquid crystal display, and includes a display 101 and an operation processor 102.

The display 101 displays various types of information.

The display 101 is configured by, for example, a CRT display, a liquid crystal display, an EL display, and the like, and is a display device such as a monitor or a line display on which an operating system or application software display electrical data such as a processing state.

The controller 12 displays an operation and a state of the digital multifunctional apparatus 1 via the display 101.

The operation processor 102 is an interface for operating the digital multifunctional apparatus 1, and receives an input operation (command) from a user.

The digital multifunctional apparatus 1 executes a job such as scanning, printing, copying, or image transmission, based on a command from a user received via the operation processor 102.

The document reader 11 detects and reads a document placed on a platen or a document conveyed from a document tray, converts the document into an appropriate electric signal, and generates image data.

The controller 12 controls an operation of each constituent component of the digital multifunctional apparatus 1, and performs detection of each sensor, and monitoring and control of all loads such as a motor, a clutch, and the operation panel 10 to control the operation of the entire digital multifunctional apparatus 1.

The controller 12 is a circuit mainly including a CPU or a microprocessor, and is mainly realized by a microcomputer including a CPU, a ROM, a RAM, an I/O controller, a timer, and the like.

The controller 12 organically operates each hardware based on a control program stored in advance in the ROM or the like to execute a voice operation function according to the present invention as described later.

The storage 13 is an element or a storage medium that stores information, a control program, and the like necessary for realizing various functions of the digital multifunctional apparatus 1. For example, a semiconductor element such as a RAM or a ROM, or a storage medium such as a hard disk, a flash storage, and an SSD is employed for the storage 13.

It is noted that a program and data may be stored in different devices, for example, so that a region where the data is stored is included in a hard disk drive and a region where the program is stored is included in a flash storage.

The storage 13 includes an audio database 130 that collects audio data to be output from the audio outputter 18 in accordance with a state of the apparatus.

The image processor 14 performs processing such as enlarging or reducing of image data read from the document reader 11 or image data acquired via the communicator 17, according to a command received by the operation processor 102, to make the image data suitable for output.

The print device 15 prints the image data generated by the document reader 11 and image-processed by the image processor 14 on a sheet.

The sheet discharger 16 conveys a sheet printed out by the print device 15 to a sheet discharge tray and discharges the sheet.

The communicator 17 communicates with an external image processing device, a computer, a mobile information terminal, an information processing device, a facsimile device, and the like via the network 4 or the like, and transmits and receives various types of information such as an e-mail, and a fax to and from the external image processing device and the like.

Further, the communicator 17 includes the LAN port 20.

The LAN port 20 includes a connection terminal for connecting a LAN cable, and transmits and receives data to and from the external voice recognition server 3 via the LAN cable.

The audio outputter 18 performs audio output to respond to the user's voice via the voice recognition server 3, and also outputs a message stored in the audio database 130 of the storage 13.

The audio outputter 18 includes the speaker 30.

### Simplified Configuration of Smart Speaker 2

Next, a simplified configuration of the smart speaker 2 will be described with reference to FIG. 3.

As illustrated in FIG. 3, the smart speaker 2 includes a voice inputter 21, an audio outputter 22, a controller 23, and a communicator 24.

The audio outputter 22 includes a speaker 220.

The communicator 24 includes a LAN port 240.

The audio outputter 22, the controller 23, and the communicator 24 have a similar configuration as the audio outputter 18, the controller 12, and the communicator 17 illustrated in FIG. 2, respectively, and thus, description thereof will be omitted.

Here, the voice inputter 21 not described in the description of FIG. 2 will be described.

The voice inputter 21 includes a microphone 210 and inputs a voice from a user.

The voice input from the voice inputter 21 is converted into audio data in a predetermined digital audio format by AD conversion, and then transmitted to the voice recognition server 3 via the communicator 24.

### Simplified Configuration of Voice Recognition Server 3

Next, a simplified configuration of the voice recognition server 3 will be described with reference to FIG. 4.

As illustrated in FIG. 4, the voice recognition server 3 includes a storage 31, an image processor 32, a display 33, an operation processor 34, a voice analyzer 35, a controller 36, a communicator 37, a message outputter 38, and an execution command outputter 39.

The communicator 37 includes a LAN port 370.

The storage 31, the image processor 32, the display 33, the operation processor 34, the controller 36, and the communicator 37 have a similar configuration as the storage 13, the image processor 14, the display 101, the operation processor 102, the controller 12, and the communicator 17 illustrated in FIG. 2, respectively, and thus, description thereof will be omitted.

Here, the voice analyzer 35, the message outputter 38, and the execution command outputter 39 not described in the description of FIG. 2 will be described.

The voice analyzer 35 analyzes the audio data received from the smart speaker 2, and identifies a command from the user.

Based on the command from the user identified by the voice analyzer 35, the message outputter 38 outputs a corresponding message to the smart speaker 2.

Based on the command from the user identified by the voice analyzer 35, the execution command outputter 39 outputs a corresponding execution command to the digital multifunctional apparatus 1.

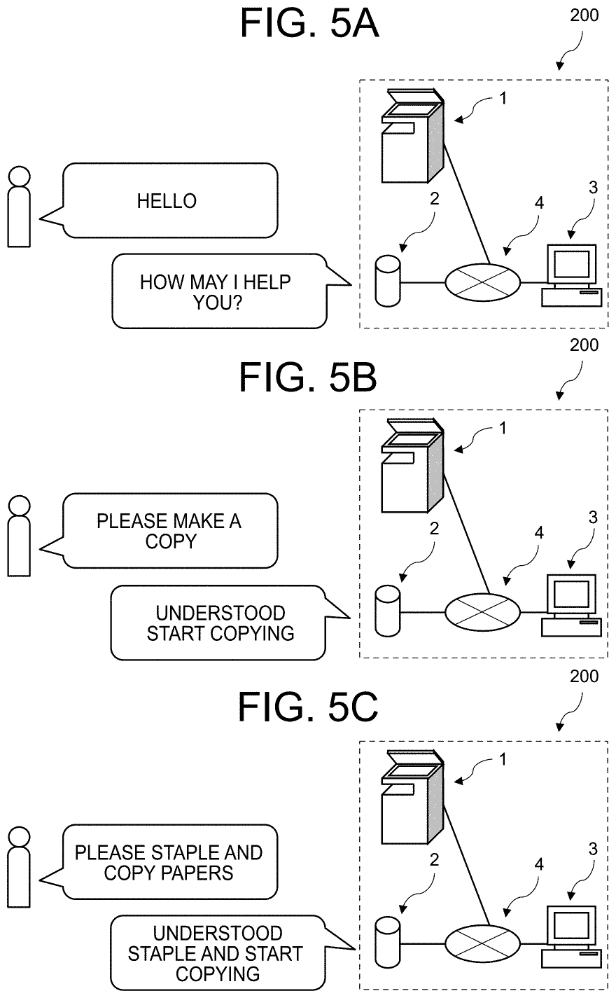

Next, a voice operation process of the digital multifunctional apparatus 1 according to the present invention will be described with reference to FIGS. 5A to 9C.

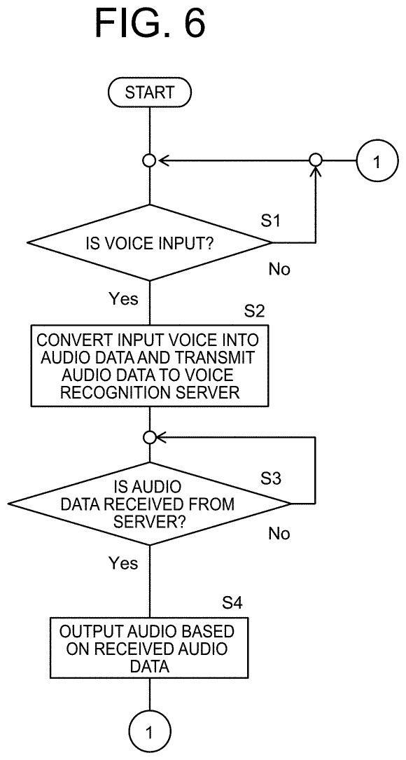

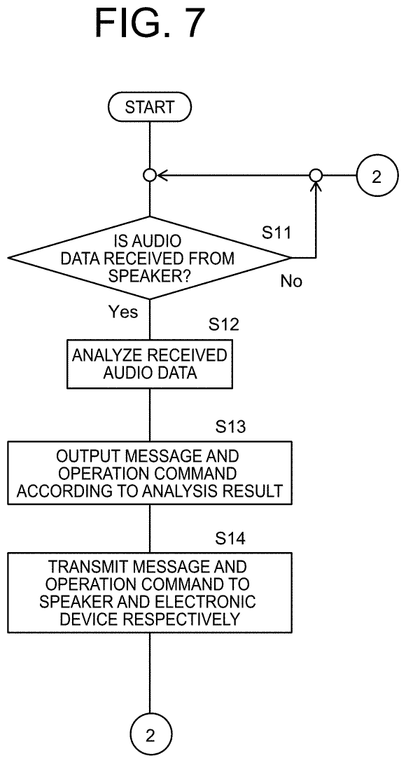

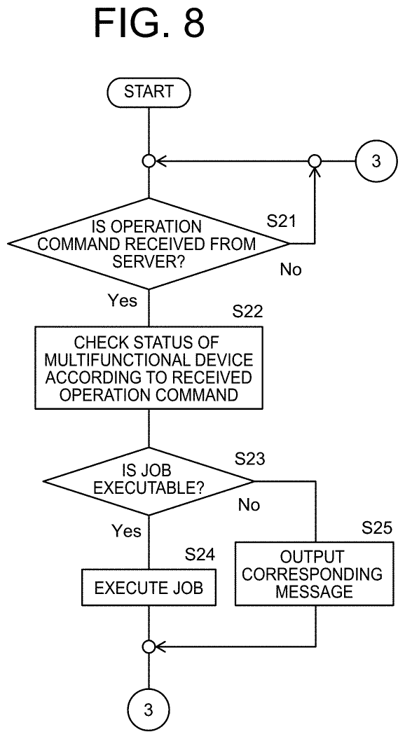

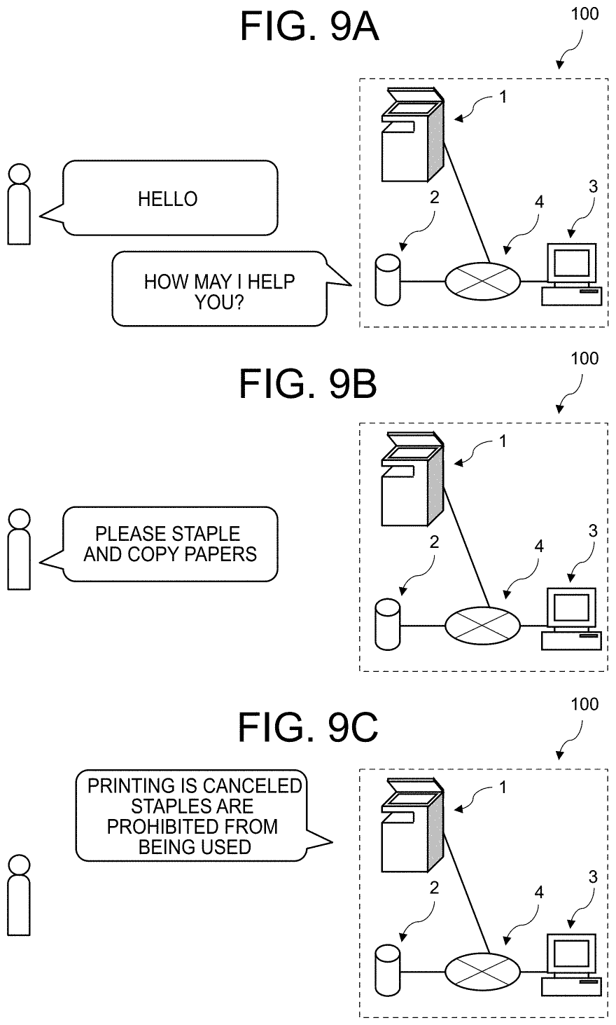

FIGS. 5A to 5C are explanatory diagrams illustrating an example of a voice operation procedure of a conventional multifunctional apparatus system 200. FIG. 6 is a flowchart illustrating a process of the smart speaker 2 in the voice operation procedure of the multifunctional apparatus system 100 illustrated in FIG. 1. FIG. 7 is a flowchart illustrating a process of the voice recognition server 3 in the voice operation procedure of the multifunctional apparatus system 100 of FIG. 1. FIG. 8 is a flowchart illustrating a process of the digital multifunctional apparatus 1 in the voice operation procedure of the multifunctional apparatus system 100 of FIG. 1. FIGS. 9A to 9C are explanatory diagrams illustrating an example of the voice operation procedure of the multifunctional apparatus system 100 of FIG. 1.

### Example of Voice Operation Procedure of Conventional Multifunctional Apparatus System 200

First, a problem in the voice operation procedure of the conventional multifunctional apparatus system 200 will be described with reference to FIGS. 5A to 5C.

As illustrated in FIG. 5A, if a user utters “Hello” to the smart speaker 2 in the conventional multifunctional apparatus system 200, the smart speaker 2 converts the voice from the user into audio data, and transmits the audio data to the voice recognition server 3 via the network 4.

Subsequently, the voice recognition server 3 analyzes the audio data received from the smart speaker 2, identifies a command from the user, and transmits a message saying “How may I help you?” in accordance with the command to the smart speaker 2.

The smart speaker 2 outputs the message received from the voice recognition server 3 to the user.

Next, as illustrated in FIG. 5B, if the user says “Please make a copy” to the smart speaker 2, the smart speaker 2 outputs a message saying “Understood. Start copying” to the user, by a process similar to that described above.

At this time, the voice recognition server 3 transmits an execution command for copying to the digital multifunctional apparatus 1, together with a message in accordance with the command from the user, to cause the digital multifunctional apparatus 1 to execute copying.

On the other hand, in a case where the digital multifunctional apparatus 1 does not have a stapling function, or the digital multifunctional apparatus 1 has a stapling function but has run out of staples, or the use of staples is prohibited, as illustrated in FIG. 5C, if the user says “Please staple and copy” to the smart speaker 2, the digital multifunctional apparatus 1 is incapable of executing a function relating to stapling.

However, the voice recognition server 3 does not have information about the stapling of the digital multifunctional apparatus 1, and thus, the voice recognition server 3 cannot recognize that the digital multifunctional apparatus 1 is incapable of executing the function relating to stapling.

As a result, even if a message saying “Understood. Start stapling and copying” is output from the smart speaker 2, there may be a problem in that the digital multifunctional apparatus 1 does not execute the stapling function.

Further, in this case, another problem is that even if the user asks the smart speaker 2 about a reason why the digital multifunctional apparatus 1 does not execute the stapling function, a satisfactory answer cannot be obtained.

In the present invention, to solve such a problem, the voice operation procedure of the multifunctional apparatus system 100 is executed according to the flowcharts in FIGS. 6 to 8.

### Process of Smart Speaker 2

A process of the smart speaker 2 in the voice operation procedure of the multifunctional apparatus system 100 will be described with reference to FIG. 6.

In step S1 of FIG. 6, the controller 23 of the smart speaker 2 determines whether a voice is input from the microphone 210 (step S1).

If there is a voice input from the microphone 210 (if Yes is determined in step S1), in step S2, the voice input from the voice inputter 21 is converted into audio data, and the communicator 24 transmits the audio data to the voice recognition server 3 (step S2).

Afterwards, the controller 23 performs the determination in step S3 (step S3).

On the other hand, if no voice is input from the microphone 210 (if No is determined in step S1), the controller 23 repeats the determination in step S1 (step S1).

Next, in step S3, the controller 23 determines whether the communicator 24 receives audio data from the voice recognition server 3 (step S3).

If the audio data is received from the voice recognition server 3 (if Yes is determined in step S3), the audio outputter 22 is caused to perform audio output based on the received audio data in step S4 (step S4).

Afterwards, the controller 23 returns the processing to step S1 (step S1).

### Process of Voice Recognition Server 3

Next, a process of the voice recognition server 3 in the voice operation procedure of the multifunctional apparatus system 100 will be described with reference to FIG. 7.

In step S11 of FIG. 7, the controller 36 of the voice recognition server 3 determines whether the communicator 37 receives audio data from the smart speaker 2 (step S11).

If the communicator 37 receives audio data from the smart speaker 2 (if Yes is determined in step S11), the voice analyzer 35 analyzes the received audio data in step S12 (step S12).

Afterwards, the controller 36 performs the process in step S13 (step S13).

On the other hand, if the communicator 37 does not receive the audio data from the smart speaker 2 (if No is determined in step S11), the controller 36 repeats the determination in step S11 (step S11).

Next, in step S13, the message outputter 38 and the execution command outputter 39 respectively output a message and an execution command (operation command) according to the analysis result (step S13).

Subsequently, in step S14, the communicator 37 transmits the message and the execution command (operation command) output in step S13 to the smart speaker 2 and the digital multifunctional apparatus 1, respectively (step S14).

Afterwards, the controller 36 returns the processing to step S11 (step S11).

### Process of Digital Multifunctional Apparatus 1

Next, a process of the digital multifunctional apparatus 1 in the voice operation procedure of the multifunctional apparatus system 100 will be described with reference to FIG. 8.

In step S21 of FIG. 8, the controller 12 of the digital multifunctional apparatus 1 determines whether the communicator 17 receives an execution command (operation command) from the voice recognition server 3 (step S21).

If the communicator 17 receives the execution command (operation command) from the voice recognition server 3 (if Yes is determined in step S21), the controller 12 confirms, in step S22, a state of the digital multifunctional apparatus 1 according to the received execution command (step S22).

Afterwards, the controller 12 returns the processing to the determination in step S23 (step S23).

On the other hand, if the communicator 17 does not receive the execution command (operation command) from the voice recognition server 3 (if No is determined in step S21), the controller 12 repeats the determination in step S21 (step S21).

Next, in step S23, the controller 12 determines, based on the state of the digital multifunctional apparatus 1 confirmed in step S22, whether it is possible to execute the job according to the received execution command (operation command) (step S23).

If it is possible to execute the job according to the received execution command (operation command) (if Yes is determined in step S23), the controller 12 executes the job in step S24 (step S24).

On the other hand, if it is not possible to execute the job according to the received execution command (if No is determined in step S23), in step S25, the audio outputter 18 outputs a corresponding message stored in the audio database 130 of the storage 13 (step S25).

After finishing the process in step S24 or S25, the controller 12 returns the processing to the determination in step S21 (step S21).

### Specific Example of Voice Operation Procedure of Multifunctional Apparatus System 100 According to First Embodiment of Present Invention

Next, a specific example of a voice operation procedure of the multifunctional apparatus system 100 according to the first embodiment of the present invention will be described with reference to FIGS. 9A to 9C.

As illustrated in FIG. 9A, if a user utters “Hello” to the smart speaker 2 in the multifunctional apparatus system 100, the smart speaker 2 outputs a message saying “How may I help you?” to the user by a procedure similar to that in FIG. 5A.

Subsequently, as illustrated in FIG. 9B, if the user says “Please staple and copy” to the smart speaker 2, the smart speaker 2 converts the voice from the user into audio data, and transmits the audio data to the voice recognition server 3 via the network 4.

Subsequently, the voice recognition server 3 analyzes the audio data received from the smart speaker 2, identifies a command from the user, and transmits, to the digital multifunctional apparatus 1, an execution command in accordance with the command.

After receiving the execution command from the voice recognition server 3, the digital multifunctional apparatus 1 confirms an execution state of a function corresponding to the received execution command.

Here, if it is possible to use the function corresponding to the received execution command, the digital multifunctional apparatus 1 executes a job of copying and stapling based on the execution command.

On the other hand, if it is not possible to use the function corresponding to the received execution command, such as when the digital multifunctional apparatus 1 does not have a stapling function, or when the digital multifunctional apparatus 1 has a stapling function but runs out of staples, or when the use of staples is prohibited, the digital multifunctional apparatus 1 subsequently outputs, from the audio outputter 18, a message indicating that it is not possible to execute the job and a reason thereof.

In the example illustrated in FIG. 9C, the digital multifunctional apparatus 1 outputs a message saying “Printing canceled. Use of staples prohibited”.

In this way, after the determination whether it is possible to execute the job corresponding to the voice command of the user input from the smart speaker 2, if it is not possible to execute the job, a message indicating that it is not possible to execute the job, a reason thereof, and the like is output from the audio outputter 18 of the digital multifunctional apparatus 1, and thus, the multifunctional apparatus system 100 capable of returning an appropriate response in accordance with the execution state is realized.

First Modification

As a first modification of the first embodiment, in a case where saving to a designated folder is prohibited during the execution of a scanning job, the digital multifunctional apparatus 1 may output a message saying “Data saving canceled. Only temporary storage folder can be used”

Second Modification

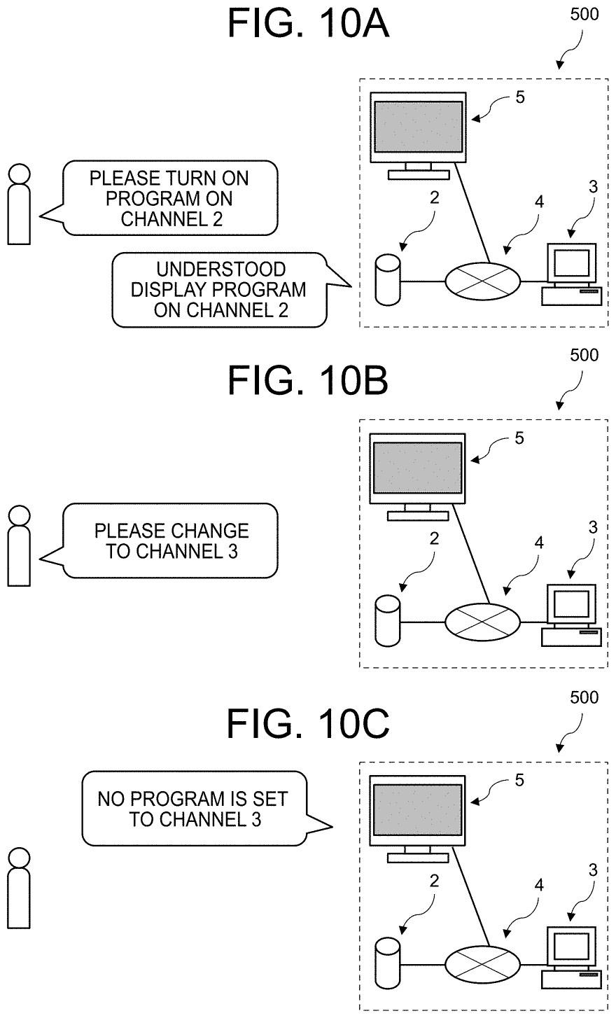

As a second modification of the first embodiment, as illustrated in FIGS. 10A to 10C, it is possible to apply the present invention to a television system 500 including a television 5.

FIGS. 10A to 10C are explanatory diagrams illustrating an example of a voice operation procedure of a television system 500 according to the first embodiment of the present invention.

In the following description, similarly to the digital multifunctional apparatus 1 of the first and second embodiments, it is assumed that the television 5 includes a storage having an audio database, and an audio outputter.

The same applies to the electric devices according to the other embodiments.

As illustrated in FIG. 10A, if the user says “Please turn on program on channel 2” to the smart speaker 2, the smart speaker 2 outputs “Understood. “Display program on channel 2”.

Afterwards, as illustrated in FIG. 10B, the user says “Please change to channel 3” to the smart speaker 2.

At this time, if a controller of the television 5 confirms that no program is set on channel 3, the audio outputter of the television 5 may output “No program is set to channel 3”, as illustrated in FIG. 10C.

In this way, after the determination whether it is possible to execute the job corresponding to the voice command of the user input from the smart speaker 2, if it is not possible to execute the job, a message indicating that it is not possible to execute the job and a reason thereof is output from the audio outputter of the television 5, and thus, the television system 500 capable of returning an appropriate response in accordance with the execution state is realized.

### Second Embodiment

### Voice Operation Procedure of Multifunctional Apparatus System 100 According to Second Embodiment of Present Invention

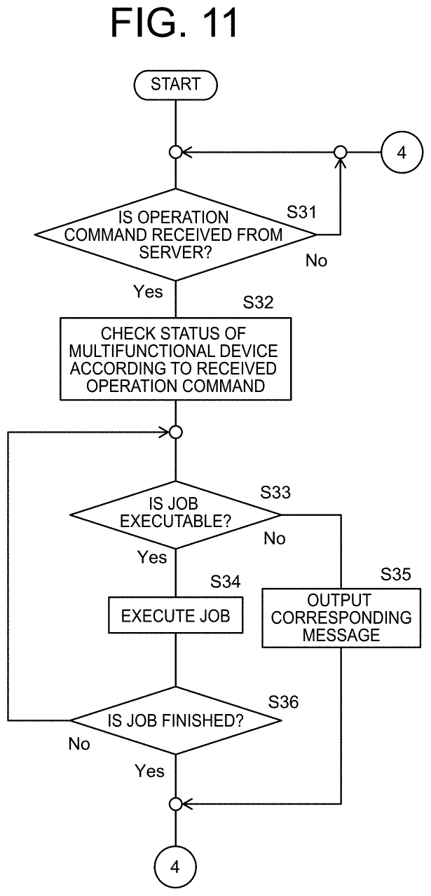

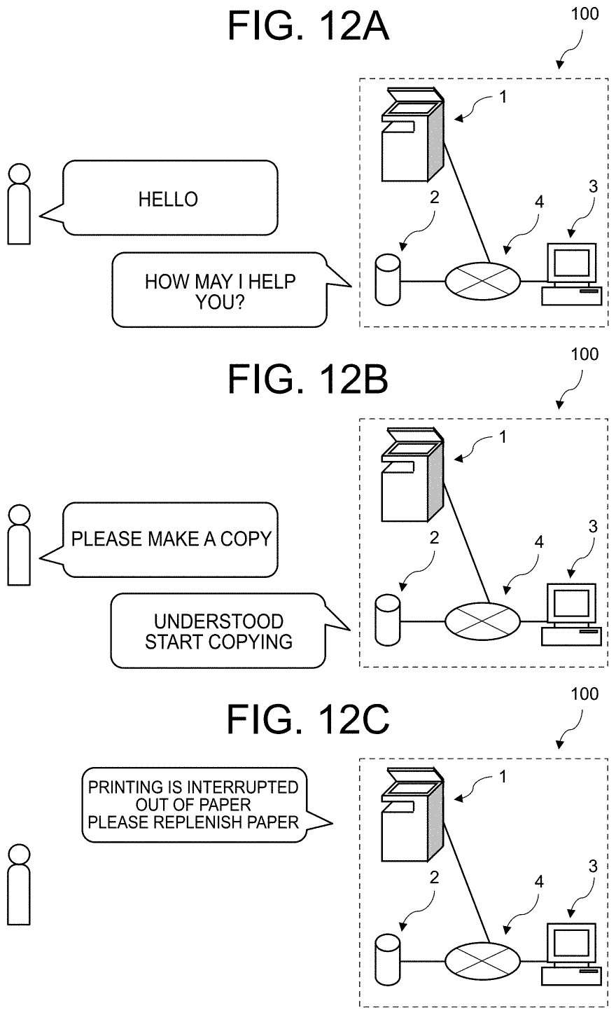

Next, an example of a voice operation procedure of the multifunctional apparatus system 100 according to a second embodiment of the present invention will be described with reference to FIG. 11 and FIGS. 12A to 12C.

FIG. 11 is a flowchart illustrating a process of an electric device in the voice operation procedure of the multifunctional apparatus system 100 according to the second embodiment of the present invention. FIGS. 12A to 12C are explanatory diagrams illustrating an example of the voice operation procedure of the multifunctional apparatus system 100 according to the second embodiment of the present invention.

The processes in steps S31 to S35 of FIG. 11 respectively correspond to the processes in steps S21 to S25 of FIG. 8, and thus, description thereof will be omitted.

The processes of the smart speaker 2 and the voice recognition server 3 are similar to the processes in FIG. 6 and FIG. 7, respectively, and thus, description thereof will be omitted.

Here, a process in step S36 of FIG. 11 not described in FIG. 8 will be described.

After executing the job in step S34 (step S34), the controller 12 determines whether the job is finished in step S36 (step S36).

If the job is finished (if Yes is determined in step S36), the controller 12 returns the processing to the determination in step S31 (step S31).

On the other hand, if the job is not finished (if No is determined in step S36), the controller 12 returns the processing to the determination in step S33 (step S33).

### Specific Example of Voice Operation Procedure of Multifunctional Apparatus System 100 According to Second Embodiment of Present Invention

Next, a specific example of a voice operation procedure of the multifunctional apparatus system 100 according to the first embodiment of the present invention will be described with reference to FIGS. 12A to 12C.

As illustrated in FIG. 12A, if a user utters “Hello” to the smart speaker 2 in the multifunctional apparatus system 100, the smart speaker 2 outputs a message saying “How may I help you?” to the user by a procedure similar to that in FIGS. 5A and 9A.

Subsequently, as illustrated in FIG. 12B, if the user says “Please make a copy” to the smart speaker 2, the smart speaker 2 outputs, to the user, a message saying “Understood. Start copying”, by a procedure similar to that in FIG. 5B.

At this time, the voice recognition server 3 transmits an execution command for copying to the digital multifunctional apparatus 1, together with a message in accordance with the command from the user, to cause the digital multifunctional apparatus 1 to execute copying.

However, if the digital multifunctional apparatus 1 runs out of paper during execution of copying, the digital multifunctional apparatus 1 outputs, from the audio outputter 18, a message indicating that copying is interrupted, a reason thereof, and the like.

In the example of FIG. 12C, the digital multifunctional apparatus 1 outputs a message saying “Printing interrupted. Out of paper. Please replenish paper”

In this way, after the execution of a predetermined job according to the voice command of the user input from the smart speaker 2, if the job can no longer be executed, a message indicating that it is not possible to execute the job, a reason thereof, and the like is output from the audio outputter 18 of the digital multifunctional apparatus 1, and thus, the multifunctional apparatus system 100 capable of returning an appropriate response in accordance with the execution state is realized.

Modification

### Specific Example of Voice Operation Procedure of Self-Propelled Vacuum Cleaner System 600 According to Second Embodiment of Present Invention

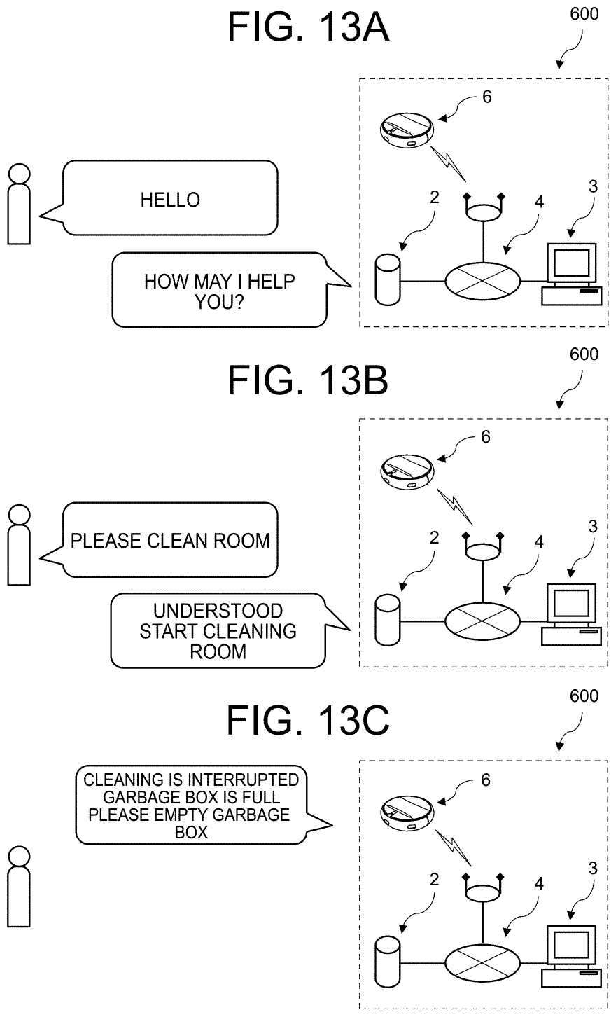

As a modification of the second embodiment, as illustrated in FIGS. 13A to 13C, it is possible to apply the present invention to a self-propelled vacuum cleaner system 600 including a self-propelled vacuum cleaner 6.

FIGS. 13A to 13C are explanatory diagrams illustrating an example of a voice operation procedure of a self-propelled vacuum cleaner system 600 according to the second embodiment of the present invention.

In the example illustrated in FIGS. 13A to 13C, the self-propelled vacuum cleaner 6 performs wireless communication with the voice recognition server 3.

As illustrated in FIG. 13A, if a user utters “Hello” to the smart speaker 2 in the self-propelled vacuum cleaner system 600, the smart speaker 2 outputs a message saying “How may I help you?” to the user by a procedure similar to that of the multifunctional apparatus system 100.

Subsequently, as illustrated in FIG. 13B, if the user says “Please clean room” to the smart speaker 2, the smart speaker 2 outputs a message saying “Understood. Start cleaning room” to the user, by a procedure similar to that of the multifunctional apparatus system 100.

At this time, the voice recognition server 3 transmits an execution command for cleaning to the self-propelled vacuum cleaner 6, together with a message in accordance with the command from the user, to cause the self-propelled vacuum cleaner 6 to execute cleaning.

However, if a garbage box of the self-propelled vacuum cleaner 6 is completely filled with dust during cleaning, the self-propelled vacuum cleaner 6 outputs, from the audio outputter, a message indicating that cleaning is interrupted, a reason thereof, and the like.

In the example illustrated in FIG. 13C, the self-propelled vacuum cleaner 6 outputs a message saying “Cleaning is interrupted. Garbage box is full. Please empty garbage box”.

In this way, in the self-propelled vacuum cleaner 6, after the execution of the job corresponding to the voice command of the user input from the smart speaker 2, if the job can no longer be executed, a message indicating that it is not possible to execute the job, a reason thereof, and the like is output from the audio outputter of the self-propelled vacuum cleaner 6, and thus, the self-propelled vacuum cleaner system 600 capable of returning an appropriate response in accordance with the execution state is realized.

### Third Embodiment

### Example of Voice Operation Procedure of Electric Cooker System 700 According to Third Embodiment of Present Invention

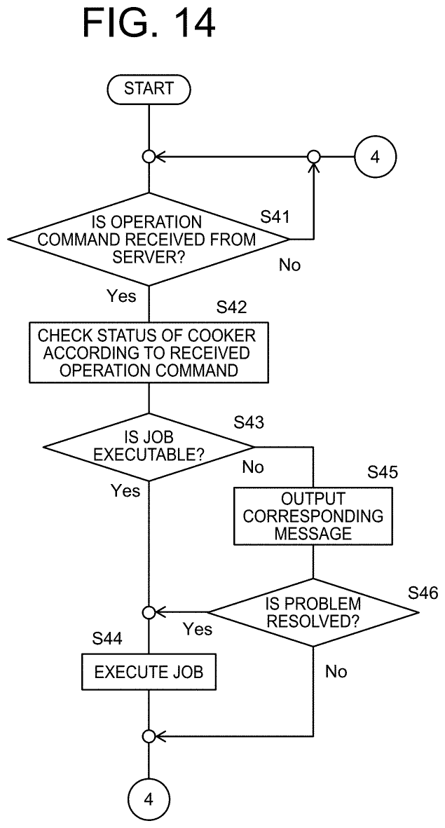

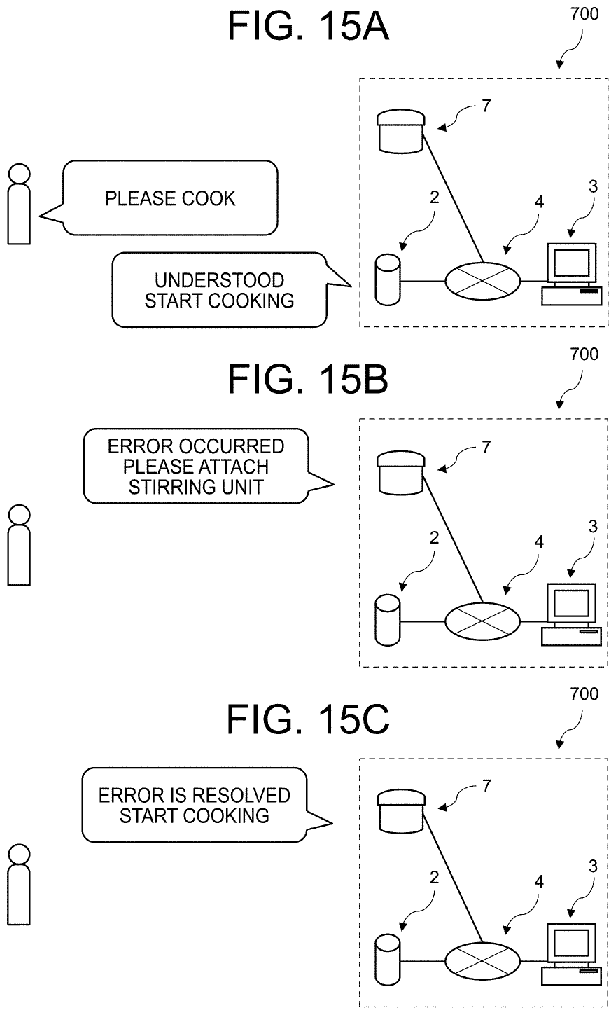

Next, an example of a voice operation procedure of an electric cooker system 700 according to a third embodiment of the present invention will be described with reference to FIG. 14 and FIGS. 15A to 15C.

FIG. 14 is a flowchart illustrating a process of an electric cooker 7 in the voice operation procedure of the electric cooker system 700 according to the third embodiment of the present invention. FIGS. 15A to 15C are explanatory diagrams illustrating an example of the voice operation procedure of the electric cooker system 700 according to the third embodiment of the present invention.

The processes in steps S41 to S45 of FIG. 14 respectively correspond to the processes in steps S21 to S25 of FIG. 8, and thus, description thereof will be omitted.

The processes of the smart speaker 2 and the voice recognition server 3 are similar to the processes in FIG. 6 and FIG. 7, respectively, and thus, description thereof will be omitted.

Here, a process in step S46 of FIG. 14 not described in FIG. 8 will be described.

After the audio outputter of the electric cooker 7 outputs the corresponding message stored in the audio database of the storage in step S45 (step S45), subsequently, in step S46, the controller confirms the execution state of the electric cooker 7, and determines whether a problem is resolved (step S46).

If the problem is resolved (if Yes is determined in step S46), the controller executes the job in step S44 (step S44).

On the other hand, if the problem is not resolved (if No is determined in step S46), the controller returns the processing to the determination in step S41 (step S41).

### Specific Example of Voice Operation Procedure of Electric Cooker System 700 According to Third Embodiment of Present Invention

Next, a specific example of a voice operation procedure of the electric cooker system 700 according to the third embodiment of the present invention will be described with reference to FIGS. 15A to 15C.

As illustrated in FIGS. 15A to 15C, the electric cooker system 700 is configured by the electric cooker 7, the smart speaker 2, the voice recognition server 3, and the network 4.

As illustrated in FIG. 15A, if a user utters “Please cook” to the smart speaker 2 in the electric cooker system 700, the smart speaker 2 outputs a message saying “Understood. Start cooking” to the user, by a procedure similar to that in the first embodiment.

Here, if the user specifies a dish for which ingredients in the electric cooker 7 need to be stirred, but the user forgets to attach a stirring unit for stirring the ingredients, an error occurs.

At this time, as illustrated in FIG. 15B, the electric cooker 7 outputs, from the audio outputter, a message indicating that it is not possible to execute the job, a reason thereof, and the like.

In the example illustrated in FIG. 15B, the electric cooker 7 outputs a message saying “Error occurred. Please attach stirring unit”.

Afterwards, if the user attaches the stirrer to the electric cooker 7, as illustrated in FIG. 15C, the electric cooker 7 outputs a message saying “Error is resolved. Start cooking”.

In this way, after the determination that it is not possible to execute the job corresponding to the voice command of the user input from the smart speaker 2, if the problem that it is not possible to execute the job is resolved, the job is executed, and thus, the electric cooker system 700 capable of returning an appropriate response in accordance with the execution state is realized.

Modification As a modification of the third embodiment, if the transmission of a fax fails because of a line disconnection or the like during transmission, a message saying “Fax transmission failed. Please establish connection” may be output, and if a cause of the transmission failure is eliminated, a message saying “Connection established. Fax transmission is executed” may be output.

### Fourth Embodiment

### Example of Voice Operation Procedure of Automatic Water Heater System 800 According to Fourth Embodiment of Present Invention

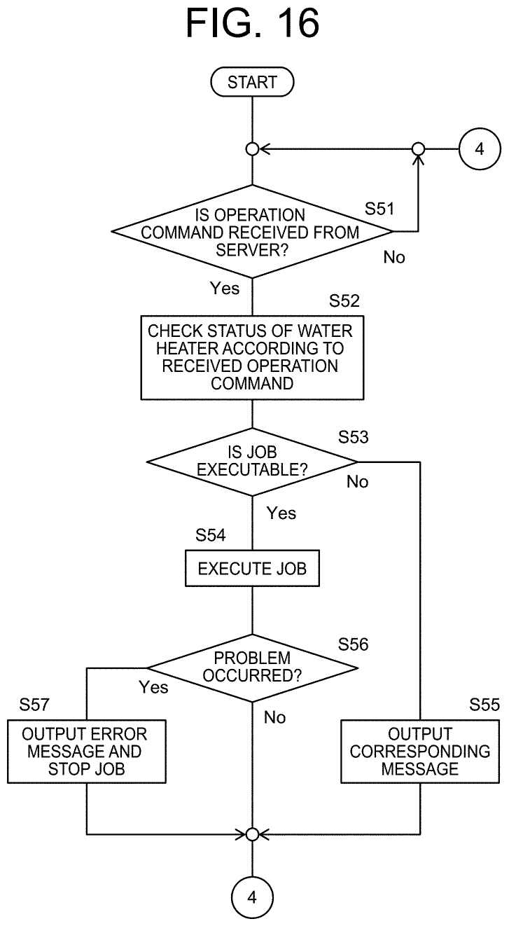

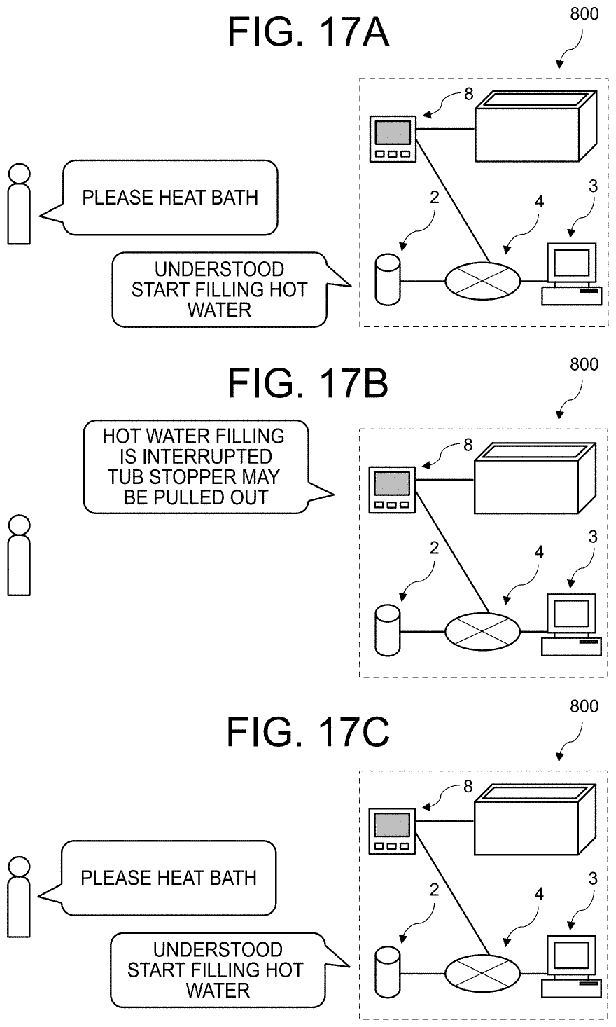

Next, an example of a voice operation procedure of an automatic water heater system 800 according to a fourth embodiment of the present invention will be described with reference to FIG. 16 and FIGS. 17A to 17C.

FIG. 16 is a flowchart illustrating a process of a remote controller 8 in the voice operation procedure of the automatic water heater system 800 according to the fourth embodiment of the present invention. FIGS. 17A to 17C are explanatory diagrams illustrating an example of the voice operation procedure of the automatic water heater system 800 according to the fourth embodiment of the present invention.

The processes in steps S51 to S55 of FIG. 16 respectively correspond to the processes in steps S21 to S25 of FIG. 8, and thus, description thereof will be omitted.

The processes of the smart speaker 2 and the voice recognition server 3 are similar to the processes in FIG. 6 and FIG. 7, respectively, and thus, description thereof will be omitted.

Here, processes in steps S56 and S57 of FIG. 16 not described in FIG. 8 will be described.

After the controller of the electric device executes the job in step S54 (step S54), subsequently, in step S56, the controller confirms the execution state of the electric device and determines whether a problem occurs (step S56).

If a problem occurs (if Yes is determined in step S56), in step S57, the controller outputs a corresponding error message stored in the audio database of the storage and stops the job (step S57).

On the other hand, if no problem occurs (if No is determined in step S56), the controller returns the processing to the determination in step S51 (step S51).

### Specific Example of Voice Operation Procedure of Automatic Water Heater System 800 According to Fourth Embodiment of Present Invention

Next, a specific example of a voice operation procedure of the automatic water heater system 800 according to the fourth embodiment of the present invention will be described with reference to FIGS. 17A to 17C.

As illustrated in FIGS. 17A to 17C, the automatic water heater system 800 includes the remote controller 8, the smart speaker 2, the voice recognition server 3, and the network 4.

As illustrated in FIG. 17A, if a user utters “Please heat bath” to the smart speaker 2 in the automatic water heater system 800, the smart speaker 2 outputs a message saying “Understood. Start filling hot water” to the user, by a procedure similar to that in the first embodiment.

Here, if a tub stopper is pulled out, the amount of hot water in the bathtub hardly increases, and thus, an error occurs.

At this time, as illustrated in FIG. 17B, the remote controller 8 outputs, from the audio outputter, a message indicating that it is not possible to execute the job, a reason thereof, and the like.

In the example illustrated in FIG. 17B, the remote controller 8 outputs a message saying “Hot water filling is interrupted. Tub stopper may be pulled out”.

Afterwards, if the user inserts the tub stopper of the bathtub, the remote controller 8 cannot confirm whether the tub stopper is inserted, however, as illustrated in FIG. 17C, if the user again utters “Please heat bath” to the smart speaker 2, the smart speaker 2 outputs a message saying “Understood. Start filling hot water” to the user, and the remote controller 8 starts filling hot water.

In this way, after the execution of the job corresponding to the voice command of the user input from the smart speaker 2, if a problem that it is not possible to execute the job occurs, the remote controller 8 outputs an indication that it is not possible to execute the job, a reason thereof, and the like and stops the job, and as a result, the automatic water heater system 800 capable of returning an appropriate response in accordance with the execution state is realized.

### Fifth Embodiment

### Example of Voice Operation Procedure of Air Conditioner System 900 According to Fifth Embodiment of Present Invention

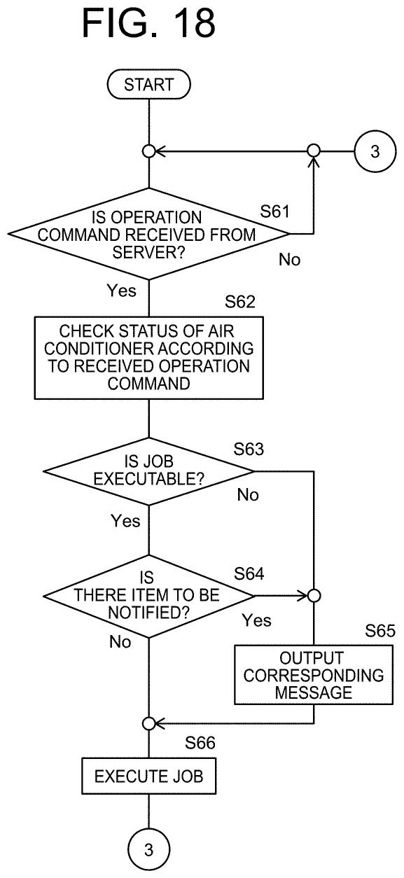

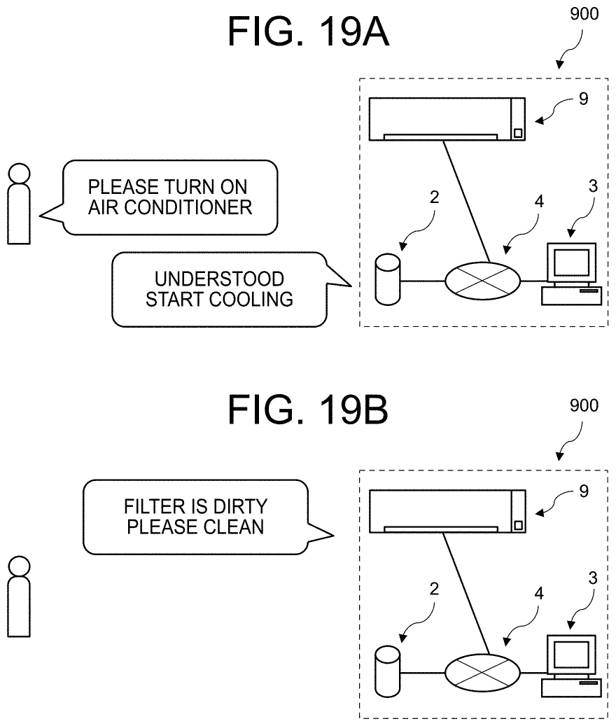

Next, an example of a voice operation procedure of an air conditioner system 900 according to a fifth embodiment of the present invention will be described with reference to FIG. 18 and FIGS. 19A and 19B.

FIG. 18 is a flowchart illustrating a process of an air conditioner 9 in the voice operation procedure of the air conditioner system 900 according to the fifth embodiment of the present invention. FIGS. 19A and 19B are explanatory diagrams illustrating an example of the voice operation procedure of the air conditioner system 900 according to the fifth embodiment of the present invention.

The processes in steps S61 to S63, S65, and S66 of FIG. 18 respectively correspond to the processes in steps S21 to S25 of FIG. 8, and thus, description thereof will be omitted.

The processes of the smart speaker 2 and the voice recognition server 3 are similar to the processes in FIG. 6 and FIG. 7, respectively, and thus, description thereof will be omitted.

Here, a process in step S64 of FIG. 18 not described in FIG. 8 will be described.

If it is possible to execute the job according to the received execution command (operation command) in step S63 (if Yes is determined in step S63), the controller confirms the execution state of the air conditioner 9, and determines whether a notification is to be sent to the user in step S64 (step S64).

Here, the notification to the user is an item informing the user that although a function is executable according to the execution command received from the voice recognition server 3, it is necessary to replace a component of the electric device, or perform maintenance.

For example, it may be necessary to clean a filter of the air conditioner if the filter is dirty.

If a notification is to be sent to the user (if Yes is determined in step S64), the controller outputs a corresponding message stored in the audio database of the storage in step S65 (step S65).

Afterwards, the controller executes the job in step S66 (step S66).

On the other hand, if no notification is to be sent to the user (if No is determined in step S64), the controller executes the job in step S66 (step S66).

### Specific Example of Voice Operation Procedure of Air Conditioner System 900 According to Fifth Embodiment of Present Invention

Next, a specific example of a voice operation procedure of the air conditioner system 900 according to the fifth embodiment of the present invention will be described with reference to FIGS. 19A and 19B.

As illustrated in FIGS. 19A and 19B, the air conditioner system 900 includes the air conditioner 9, the smart speaker 2, the voice recognition server 3, and the network 4.

As illustrated in FIG. 19A, if a user utters “Please turn on air conditioner” to the smart speaker 2 in the air conditioner system 900, the smart speaker 2 outputs a message saying “Understood. Start cooling” to the user, by a procedure similar to that in the first embodiment.

Here, if a filter is dirty and the rate of cooling is poor, a notification is sent to the user.

At this time, as illustrated in FIG. 19B, the air conditioner 9 outputs a notification to the user from the audio outputter.

In the example illustrated in FIG. 19B, the air conditioner 9 outputs a message saying “Filter is dirty. Please clean”.

Afterwards, the air conditioner 9 executes the job.

In this way, if there is a notification regarding the function corresponding to the voice command of the user input from the smart speaker 2, the air conditioner 9 outputs the notification, and thus, the air conditioner system 900 capable of returning an appropriate response in accordance with the execution state is realized.

Preferred aspects of the present invention include combinations of any aspects among the above-described plurality of aspects.

In addition to the above-described embodiments, various modifications of the present invention are possible. These modifications should not be interpreted as not belonging to the scope of the present invention. The present invention shall include a meaning equivalent to the claims and all modifications within the scope.

### DESCRIPTION OF REFERENCE NUMERALS

1: Digital multifunctional apparatus, 2: Smart speaker, 3: Voice recognition server, 4: Network, 5: Television, 6: Self-propelled vacuum cleaner, 7: Electric cooker, 8: Remote controller, 9: Air conditioner, 10: Operation Panel, 11: Document reader, 12, 23, 36: Controller, 13, 31: Storage, 14, 32: Image processor, 15: Print device, 16: Sheet discharger, 17, 24, 37: Communicator, 18, 22: Audio outputter, 20, 240, 370: LAN port, 21: Voice inputter, 30, 220: Speaker, 33, 101: Display, 34, 102: Operation processor, 35: Voice analyzer, 38: Message outputter, 39: Execution command outputter, 100: Multifunctional apparatus system, 130: Audio database, 200: Conventional multifunctional apparatus system, 210: Microphone, 500: Television system, 600: Self-propelled vacuum cleaner system, 700: Electric cooker system, 800: Automatic water heater system, 900: Air conditioner system

What is claimed is:

1. An electric device, comprising:
a function executer that executes a predetermined function;
a communicator that communicates with a voice recognition server recognizing a voice command input by a user through an external voice input/output device and receives a command to execute the predetermined function, which corresponds to the voice command, from the voice recognition server;
an execution state detector that detects an execution state of the predetermined function;
a message outputter that outputs a message related to the execution state of the predetermined function; and
a controller that controls the function executer, the communicator, the execution state detector, and the message outputter,
wherein, when the communicator receives the command to execute the predetermined function from the voice recognition server, the controller causes the execution state detector to detect the execution state of the predetermined function,
wherein the controller causes the function executer to execute the predetermined function if the execution state detector detects that the predetermined function is executable, and
wherein the controller causes the message outputter to output the message related to the execution state of the predetermined function if the execution state detector detects that the predetermined function is not executable.

2. The electric device according to claim 1, wherein, when the controller causes, after the communicator receives the command to execute the predetermined function from the voice recognition server, the function executer to execute the predetermined function assuming that the predetermined function is executable, the controller causes the message outputter to output the message related to the execution state of the predetermined function if the execution state detector subsequently detects that the predetermined function is no longer executable.

3. The electric device according to claim 1, wherein, when the controller causes, after the communicator receives the command to execute the predetermined function from the voice recognition server, the message outputter to output the message related to the execution state of the predetermined function assuming that the predetermined function is not executable, the controller causes the function executer to execute the predetermined function if the execution state detector subsequently detects that the predetermined function has become executable.

4. The electric device according to claim 1, further comprising an error detector that detects abnormalities in the execution state of the predetermined function,
wherein, when the controller causes, after the communicator receives the command to execute the predetermined function from the voice recognition server, the function executer to execute the predetermined function assuming that the predetermined function is executable, the controller causes the message outputter to output a message related to an abnormality in the execution state of the predetermined function and causes the function executor to stop executing the predetermined function if the error detector detects the abnormality in the execution state of the predetermined function.

5. The electric device according to claim 1,
wherein, when the communicator receives the command to execute the predetermined function from the voice recognition server, the controller causes the execution state detector to detect the execution state of the predetermined function, and
wherein the controller causes the message outputter to output a message related to a state requiring attention if the execution state detector detects that the predetermined function is executable but the execution state of the predetermined function is in the state requiring attention.

6. The electric device according to claim 1, wherein the function executer executes an image forming function to form images.

7. A method of controlling an electric device that communicates with a voice recognition server recognizing a voice command input by a user through an external voice input/output device and executes a predetermined function corresponding to the voice command according to a command from the voice recognition server, the method comprising:
communicating with the voice recognition server and receiving a command to execute a function corresponding to the voice command from the voice recognition server;
detecting an execution state of the function;
executing the function; and
outputting a message related to the execution state of the function,
wherein, when the command to execute the function is received from the voice recognition server in the receiving, the execution state of the function is detected in the detecting and, if it is detected that the function is executable, the function is executed in the executing, and
wherein, if it is detected in the detecting that the function is not executable, the message related to the execution state of the function is output in the outputting.

8. A non-transitory recording medium storing a control program for an electric device that communicates with a voice recognition server recognizing a voice command input by a user through an external voice input/output device and executes a predetermined function corresponding to the voice command according to a command from the voice recognition server, the control program causing a processor of the electric device to execute:
a communication process for communicating with the voice recognition server and receiving a command to execute a function corresponding to the voice command from the voice recognition server;
an execution state detection process for detecting an execution state of the function;
a function execution process for executing the function; and
a message output process for outputting a message related to the execution state of the function,
wherein, when the command to execute the function is received from the voice recognition server in the communication process, the execution state of the function is detected in the execution state detection process and, if it is detected that the function is executable, the function is executed in the function execution process, and
wherein, if it is detected in the execution state detection process that the function is not executable, the message related to the execution state of the function is output in the message output process.
